(19) United States
(12) Patent Application Publication
(10) Pub. No.: US 2021/0039258 A1
(43) Pub. Date: Feb. 11, 2021

(54) APPARATUS, SYSTEM, AND METHOD FOR ROBOTIC DATACENTER MONITORING

(71) Applicant: Facebook Technologies, LLC, Menlo Park, CA (US)

(72) Inventors: Curt Alan Meyers, San Jose, CA (US); Todd Meaney, Mountain View, CA (US); Scott Wiley, Los Alots, CA (US); Alan Dean Olsen, Pleasanton, CA (US); Harold Mark Bain, Palo Alto, CA (US); Ryan Christopher Cargo, Bend, OR (US); Ryan David Olson, El Cerrito, CA (US)

(21) Appl. No.: 16/986,652

(22) Filed: Aug. 6, 2020

Related U.S. Application Data
(63) Continuation of application No. 62/883,629, filed on Aug. 6, 2019.

(51) Int. Cl. B25J 9/16; B25J 9/04; G05D 1/02; G05D 1/00; G06K 9/00

(52) U.S. Cl. CPC B25J 9/1674; B25J 9/042; G05D 1/0242; G05D 2201/0209; G05D 1/0094; G06K 9/00288; G05D 2201/0207; G05D 1/0282

(57) ABSTRACT

The disclosed robotic monitoring system may include (1) a mobility subsystem for moving the robotic monitoring system through a datacenter, (2) at least one sensor for sensing information about the datacenter as the robotic monitoring system moves through the datacenter, (3) a payload subsystem for mounting the at least one sensor to the robotic monitoring system, and/or (4) a computation and navigation subsystem for recording the information about the datacenter and controlling the mobility subsystem. Various other apparatuses, systems, methods, and computer-readable media are also disclosed.

### CROSS REFERENCE TO RELATED APPLICATION

This application claims the benefit of U.S. Provisional Application No. 62,883,629, filed Aug. 6, 2019, the disclosures of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a block diagram of an exemplary robotic monitoring system in accordance with various embodiments.

FIG. 2 is a block diagram of an exemplary computation and navigation subsystem in accordance with various embodiments.

FIG. 3 is a block diagram of an exemplary datacenter monitoring system in accordance with various embodiments.

FIG. 4 is a block diagram of an exemplary implementation of a datacenter monitoring system in accordance with various embodiments.

FIG. 5 is an illustration of an exemplary robotic monitoring system in accordance with various embodiments.

FIG. 6 is an exploded-view illustration of an exemplary robotic monitoring system in accordance with various embodiments.

FIG. 7 is an illustration of an exemplary robotic monitoring system in accordance with various embodiments.

FIG. 8 is an illustration of an exemplary robotic arm in accordance with various embodiments.

FIG. 9 is an illustration of an exemplary implementation of a rack dolly subsystem in accordance with various embodiments.

FIG. 10 is an illustration of an exemplary datacenter in which a robotic monitoring system is implemented in accordance with various embodiments.

FIG. 11 is an illustration of an exemplary server rack in accordance with various embodiments.

FIG. 12 is an illustration of an exemplary datacenter in which a robotic monitoring system is implemented in accordance with various embodiments.

FIG. 13 is a flow diagram of an exemplary method for robotic datacenter monitoring in accordance with various embodiments.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to apparatuses, systems, and methods for robotic datacenter monitoring. Datacenters may include and/or represent sites for housing numerous computing devices that store, process, and/or transmit data (e.g., digital data). The computing devices housed in datacenters may benefit from certain types of monitoring capable of uncovering unexpected needs and/or failures. In some examples, such monitoring may lead to the discovery of certain maintenance, replacement, and/or upgrading needs among the computing devices and/or their surrounding environments. Additionally or alternatively, such monitoring may lead to the discovery and/or detection of unexpected failures among the computing devices and/or their surrounding environments.

As will be described in greater detail below, by monitoring datacenters for such unexpected needs and/or failures, the various apparatuses, systems, and methods disclosed herein may be able to discover certain maintenance, replacement, and/or upgrading needs or certain device failures and/or concerns in advance or with minimal downtime. In one example, an unexpected temperature increase or electrical load increase may indicate that one or more computing devices have failed or may soon fail. In this example, the various apparatuses, systems, and methods disclosed herein may sense such an increase and then determine that one or more of those computing devices have failed or may soon fail based at least in part on that increase.

In another example, certain environmental constraints, such as temperature range and/or humidity range, may affect and/or improve computing operations and/or performance in datacenters. In this example, the various apparatuses, systems, and methods disclosed herein may sense a change in temperature and/or humidity and then perform one or more actions (e.g., notify an administrator and/or modify the temperature or humidity) in response to the sensed change.

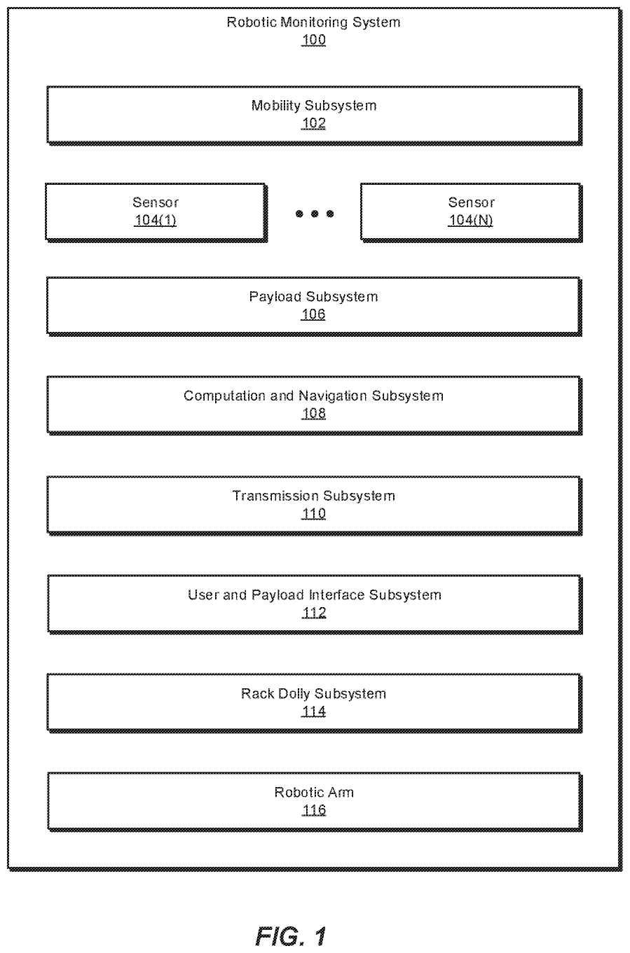

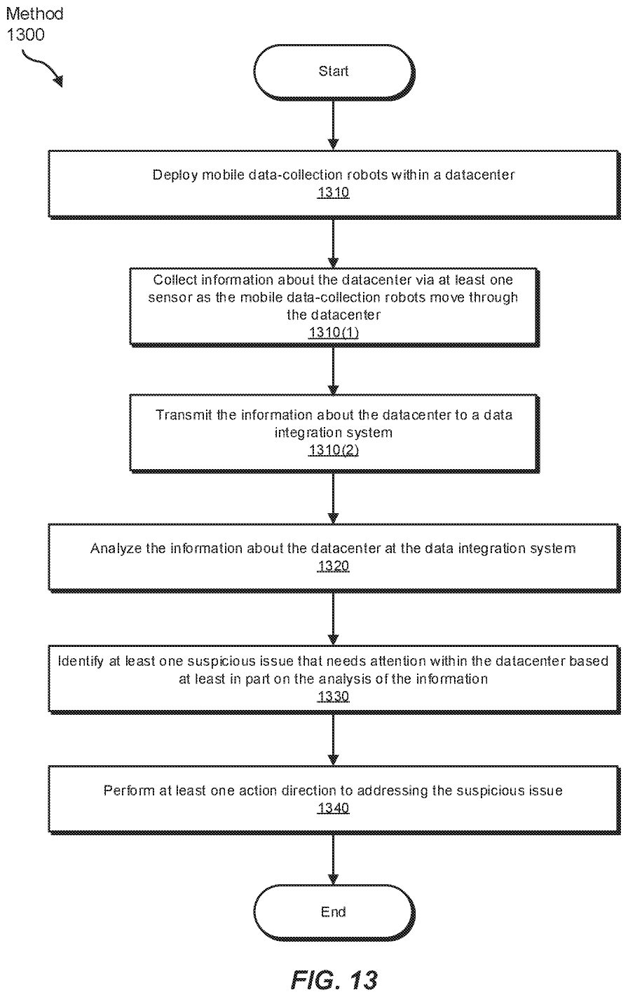

The following will provide, with reference to FIGS. 1-12, detailed descriptions of various apparatuses, systems, subsystems, components, and/or implementations that facilitate and/or contribute to robotic datacenter monitoring. The discussion corresponding to FIG. 13 will provide detailed descriptions of an exemplary method for robotic datacenter monitoring.

FIG. 1 is a block diagram of a robotic monitoring system 100 that facilitates monitoring datacenters for unexpected issues may need attention. In some examples, robotic monitoring system 100 may represent and/or be implemented or deployed as a mobile data-collection robot. As illustrated in FIG. 1, robotic monitoring system 100 may include and/or represent a mobility subsystem 102, one or more sensors 104(1)-(N), a payload subsystem 106, a computation and navigation subsystem 108, a transmission subsystem 110, a user and payload interface subsystem 112, a rack dolly subsystem 114, and/or a robotic arm 116.

In some embodiments, robotic monitoring system 100 may include and/or be implemented with a subset (e.g., less than all) of the features, components, and/or subsystems illustrated in FIG. 1. In other embodiments, robotic monitoring system 100 may include and/or be implemented with one or more additional features, components, and/or subsystems that are not explicitly illustrated in FIG. 1. For example, robotic monitoring system 100 may include and/or be implemented with a sanitation subsystem involving an ultraviolet lamp (e.g., ultraviolet C light and/or irradiation generated by low-pressure mercury vapor arc lamps) and/or an acoustic vibration generator. Such a sanitation subsystem may enable robotic monitoring system 100 to sanitize certain areas and/or environments (by, e.g., killing viruses) within datacenters.

Additionally or alternatively, although illustrated separately in FIG. 1, some of the features, components, and/or subsystems illustrated in FIG. 1 may represent and/or be implemented as portions of a single feature, component, and/or subsystem. In other words, some of the features, components, and/or subsystems illustrated in FIG. 1 may overlap and/or be combined with one another in or as a single unit.

In some examples, mobility subsystem 102 may include and/or represent certain components that facilitate moving, driving, and/or steering robotic monitoring system 100 in and/or around a datacenter. Examples of such components include, without limitation, motors (such as direct current motors, alternating current motors, vibration motors, brushless motors, switched reluctance motors, synchronous motors, rotary motors, servo motors, coreless motors, stepper motors, and/or universal motors), axles, gears, drivetrains, wheels, treads, steering mechanisms, circuitry, electrical components, processing devices, memory devices, circuit boards, power sources, wiring, batteries, communication buses, combinations or variations of one or more of the same, and/or any other suitable components. In one example, one or more of these components may move, turn, and/or rotate to drive or implement locomotion for robotic monitoring system 100.

In some examples, mobility subsystem 102 may include and/or represent a computation assembly (including, e.g., at least one processor and associated computational elements, memory, and/or wireless or wired communication interfaces), a drivetrain (including, e.g., at least one motor and/or wheels), a navigation sensing assembly (including, e.g., a proximity sensor, an accelerometer, a gyroscope, and/or a location sensor), power systems (including, e.g., a power source, a power transmission element, a power supply element, and/or a charging element), and/or an emergency stop feature (e.g., a brake).

In some examples, sensors 104(1)-(N) may facilitate and/or perform various sensing, detection, and/or identification functions for robotic monitoring system 100. Examples of sensors 104(1)-(N) include, without limitation, active or passive radio-frequency identification sensors, real time location systems, vision-based barcode scanners, ultra-wideband sensors, video cameras, computer or machine vision equipment, infrared cameras, audio microphones or sensors, pressure sensors, liquid sensors, Three-dimensional (“3D”) LiDAR sensors, air velocity sensors (3D speed and/or direction), high-resolution machine vision cameras, temperature sensors, humidity sensors, leak detectors, proximity sensors, time-of-flight depth sensors, single-beam or sweeping laser rangefinders, heat sensors, motion sensors, gyroscopes, combinations or variations of one or more of the same, and/or any other suitable sensors.

In some examples, payload subsystem 106 and/or user and payload interface subsystem 112 may include and/or represent certain components that support peripherals and/or sensing elements, such as sensors 104(1)-(N), on robotic monitoring system 100. Examples of such components include, without limitation, circuitry, electrical components, processing devices, circuit boards, user interfaces, input ports, input devices, wiring, communication buses, combinations or variations of one or more of the same, and/or any other suitable components. In one example, one or more of these components may move, turn, and/or rotate to drive or implement locomotion for robotic monitoring system 100. In one example, payload subsystem 106 and/or user and payload interface subsystem 112 may include a mast that supports peripherals and sensing elements and/or connects the same to robotic monitoring system 100. Such peripherals and/or sensing elements may be designed for datacenter and/or point-of-presence site (POP-site) applications.

In some examples, payload subsystem 106 and/or user and payload interface subsystem 112 may include video-calling hardware infrastructure that enables a remote user to participate in a video call with a local user at and/or via robotic monitoring system 100. Such a video call may enable the remote user to view and/or evaluate different regions of the datacenter and/or to communicate with the local user at or near robotic monitoring system 100 in the datacenter. In one embodiment, the mast may also support one or more flash elements and/or light sources positioned to illuminate certain features and/or targets within the datacenter and/or to improve image captures.

In some examples, computation and navigation subsystem 108 may include and/or represent components that facilitate and/or perform calculations, decision-making, navigation, issue detection, data storage or collection, output generation, transmission controls, security controls, and/or periphery or sensory controls. Examples of such components include, without limitation, circuitry, electrical components, processing devices, memory devices, circuit boards, wiring, communication buses, combinations or variations of one or more of the same, and/or any other suitable components. In one example, computation and navigation subsystem 108 may direct and/or control the functionality of one or more of the other features, components, and/or subsystems (e.g., mobility subsystem 102, transmission subsystem 110, rack dolly subsystem 114, robotic arm 116, etc.) illustrated in FIG. 1. Additionally or alternatively, computation and navigation subsystem 108 may receive and/or obtain data or information from one or more of the other features, components, and/or subsystems (e.g., mobility subsystem 102, sensors 104(1)-(N), rack dolly subsystem 114, robotic arm 116, etc.) illustrated in FIG. 1.

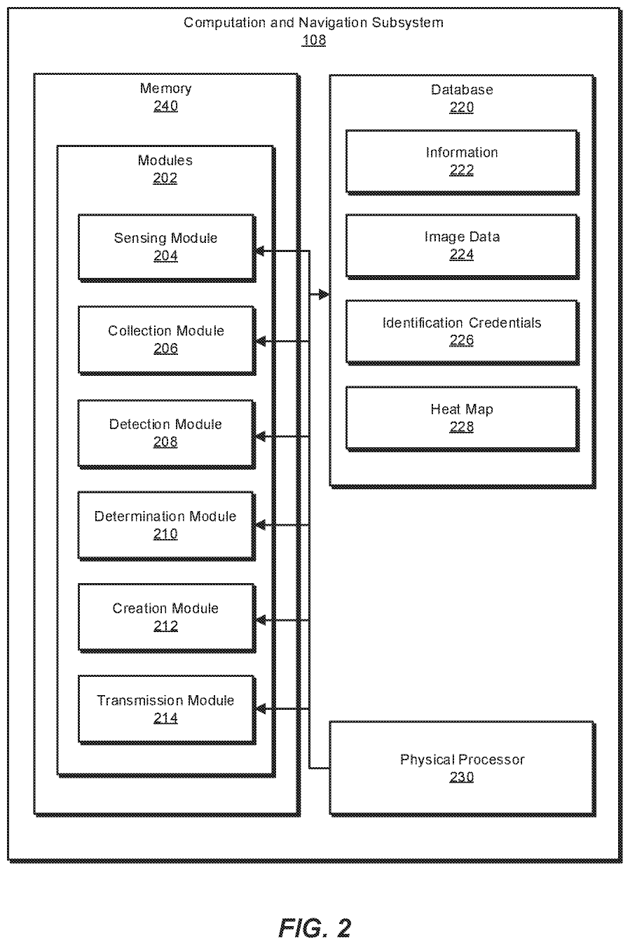

FIG. 2 is a block diagram of computation and navigation subsystem 108 that facilitates, controls, and/or performs various functions in support and/or furtherance of datacenter monitoring. In some examples, computation and navigation subsystem 108 may constitute and/or represent the brains and/or control center of robotic monitoring system 100. As illustrated in FIG. 2, computation and navigation subsystem 108 may include and/or represent one or more modules 202 for performing one or more tasks. For example, modules 202 may include and/or represent a sensing module 204, a collection module 206, a detection module 208, a determination module 210, a creation module 212, and/or a transmission module 214. In this example, modules 202 may enable, direct, and/or cause robotic monitoring system 100 and/or data integration system 302 to perform the various functions and/or tasks described throughout the instant application. Although illustrated as separate elements, one or more of modules 202 in FIG. 2 may represent portions of a single module, application, process, and/or operating system.

In certain embodiments, one or more of modules 202 in FIG. 2 may represent one or more software applications or programs that, when executed by a computing device, cause the computing device to perform one or more tasks. For example, and as will be described in greater detail below, one or more of modules 202 may represent modules stored and configured to run on one or more computing devices, including any of the various devices illustrated in FIGS. 1-12. One or more of modules 202 in FIG. 2 may also represent all or portions of one or more special-purpose computers configured to perform one or more tasks.

As illustrated in FIG. 2, computation and navigation subsystem 108 may also include one or more memory devices, such as memory 240. Memory 240 generally represents any type or form of volatile or non-volatile storage device or medium capable of storing data and/or computer-readable instructions. In one example, memory 240 may store, load, and/or maintain one or more of modules 202. Examples of memory 240 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 2, exemplary computation and navigation subsystem 108 may also include one or more physical processing devices, such as physical processor 230. Physical processor 230 generally represents any type or form of hardware-implemented processing device capable of interpreting and/or executing computer-readable instructions. In one example, physical processor 230 may access and/or modify one or more of modules 202 stored in memory 240. Additionally or alternatively, physical processor 230 may execute one or more of modules 202 to facilitate robotic datacenter monitoring. Examples of physical processor 230 include, without limitation, Central Processing Units (CPUs), microprocessors, microcontrollers, Field-Programmable Gate Arrays (FPGAs) that implement softcore processors, Application-Specific Integrated Circuits (ASICs), processing circuitry or components, portions of one or more of the same, variations or combinations of one or more of the same, and/or any other suitable physical processor.

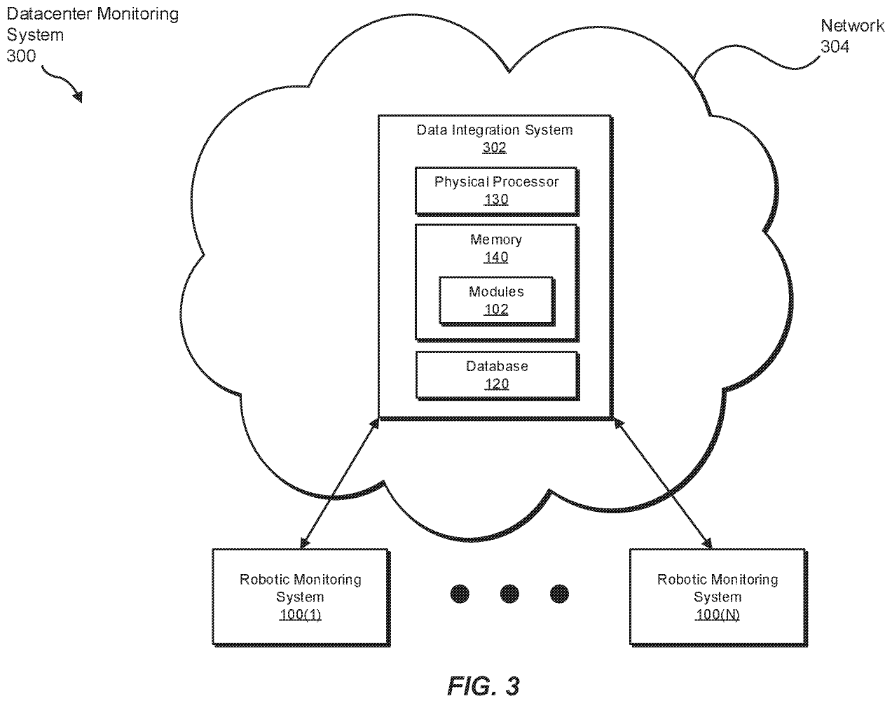

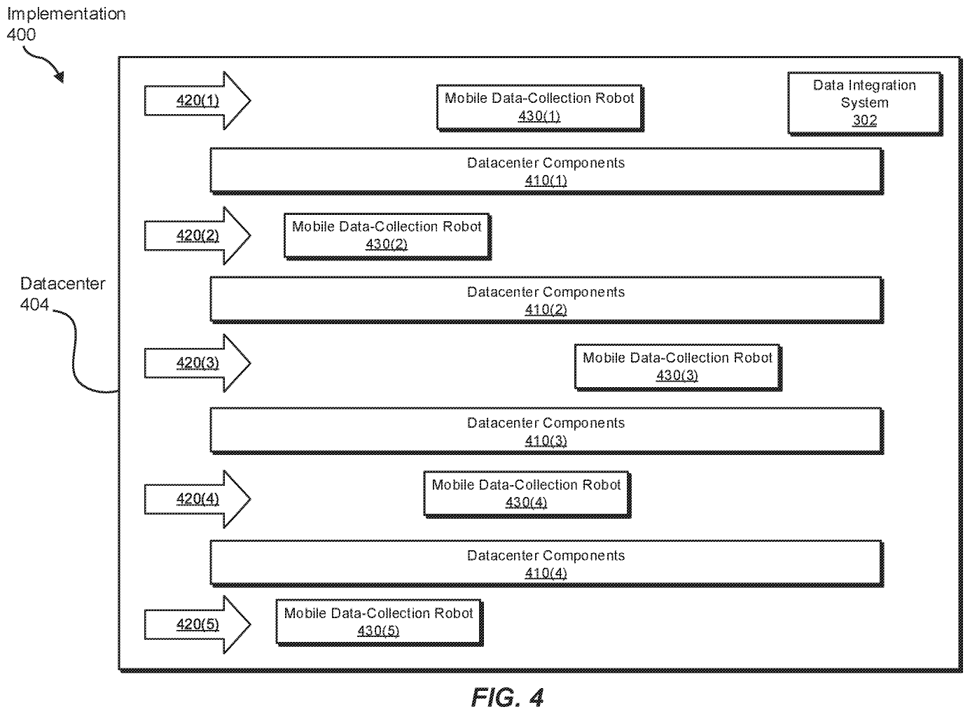

Returning to FIG. 1, transmission subsystem 110 may include and/or represent components that facilitate and/or perform wireless or wired data transmissions. Examples of such components include, without limitation, circuitry, electrical components, processing devices, memory devices, circuit boards, wiring, communication buses, receiving antennae, transmitting antennae, signal generators, modulators, processing devices, memory devices, communication interfaces, combinations or variations of one or more of the same, and/or any other suitable components. In one example, transmission subsystem 110 may send and/or transmit data and/or information from robotic monitoring system 100 to one or more devices (e.g., data integration system 302 in FIG. 3 or 4) within or outside the datacenter.

In some examples, rack dolly subsystem 114 and/or robotic arm 116 may include and/or represent components that facilitate moving, replacing, and/or relocating hardware and/or devices in the datacenter. Examples of such components include, without limitation, actuators, motors, pins, rods, levers, shafts, arms, knobs, circuitry, electrical components, processing devices, memory devices, circuit boards, wiring, communication buses, combinations or variations of one or more of the same, and/or any other suitable components. In one example, rack dolly subsystem 114 and/or robotic arm 116 may grasp, hold, lift, and/or release hardware and/or devices in the datacenter.

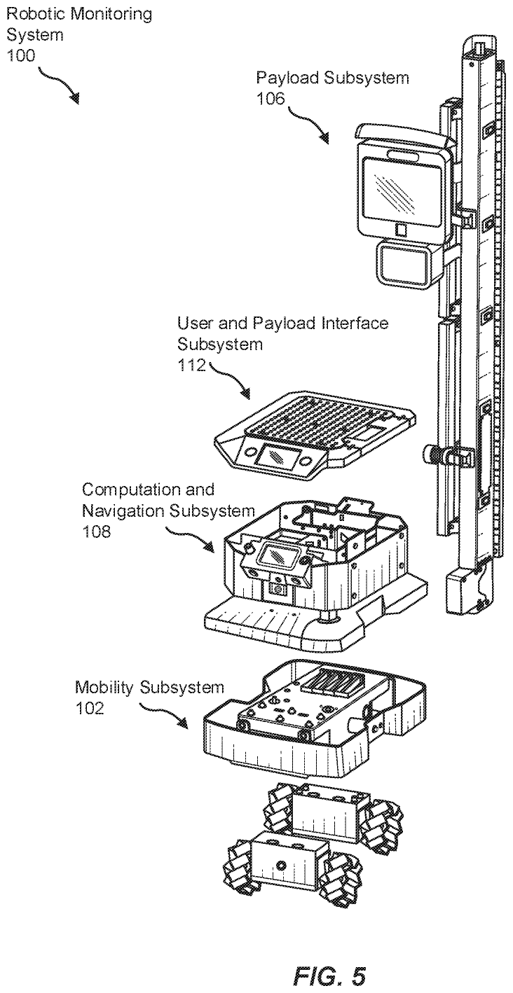

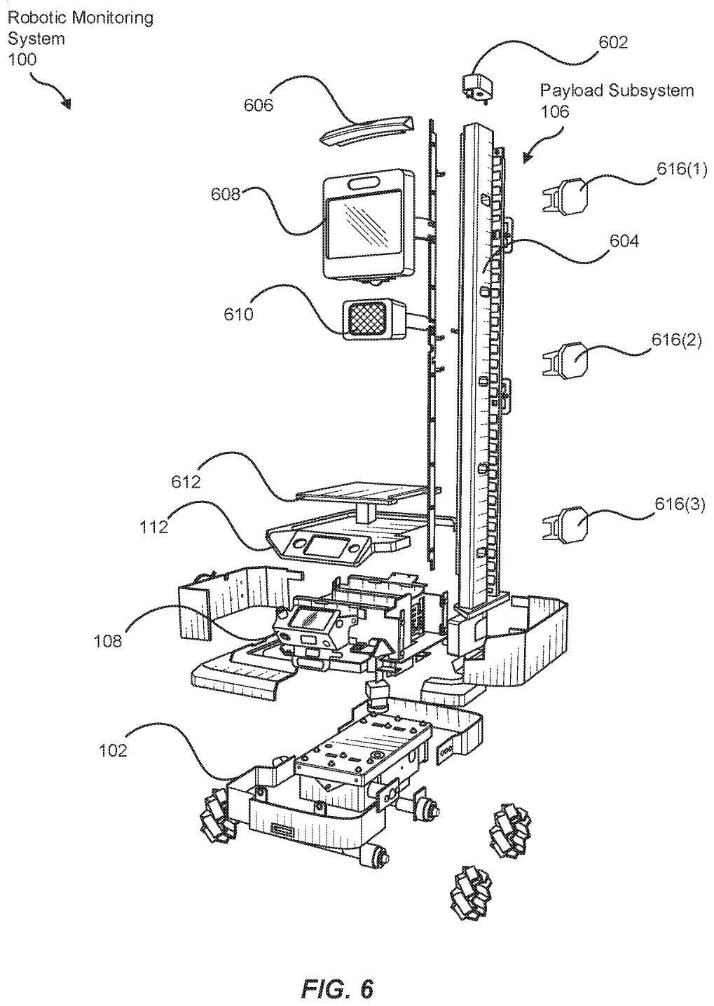

FIG. 5 is an illustration of an exemplary implementation of robotic monitoring system 100, and FIG. 6 is an exploded-view illustration of an exemplary implementation of robotic monitoring system 100. As illustrated in FIGS. 5 and 6, robotic monitoring system 100 may include and/or represent mobility subsystem 102, computation and navigation subsystem 108, user and payload interface subsystem 112, and/or payload subsystem 106. Although not necessarily illustrated in this way in FIGS. 5 and 6, the various subsystems included in robotic monitoring system 100 may be assembled and/or connected to one another, thereby putting and/or converting robotic monitoring system 100 into working condition and/or form.

As illustrated in FIG. 6, payload subsystem 106 may include and/or represent a light source 602, a mast 604, a flash element 606, a display with integrated camera 608, an audio speaker 610, and/or radio-frequency identification sensors 616(1), 616(2), and 616(3). In addition, user and payload interface subsystem 112 may include and/or represent a mechanical interface 612. In one example, mechanical interface 612 may support and/or facilitate mounting one or more objects to robotic monitoring system 100.

In some examples, robotic monitoring system 100 may represent and/or provide a platform designed for modularity. For example, mobility subsystem 102, computation and navigation subsystem 108, user and payload interface subsystem 112, and/or payload subsystem 106 may represent different modules capable of being assembled as and/or installed on robotic monitoring system 100. In this example, one or more of these modules may be omitted, excluded, and/or removed from robotic monitoring system 100 while the other modules remain intact as part of robotic monitoring system 100. Moreover, additional modules (not necessarily illustrated in FIG. 5 or 6) may be added to and/or installed on robotic monitoring system 100. For example, the same hardware and/or software incorporated into computation and navigation subsystem 108 may alternatively be attached to and/or installed on robotic monitoring system 100 as a different module (e.g., a server rack tug).

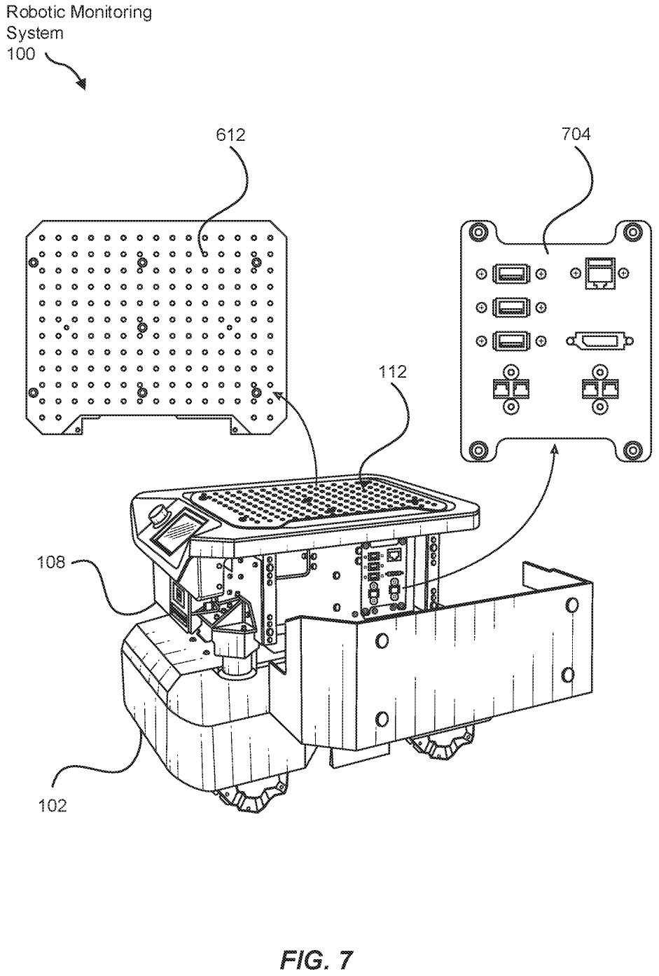

FIG. 7 is an illustration of an exemplary implementation of robotic monitoring system 100. As illustrated in FIG. 7, robotic monitoring system 100 may include and/or represent an ensemble of mobility subsystem 102, computation and navigation subsystem 108, and/or user and payload interface subsystem 112. In one example, user and payload interface subsystem 112 may include and/or incorporate a mechanical interface 612 (e.g., a textured plate) that supports and/or facilitates mounting certain objects to robotic monitoring system 100. Additionally or alternatively, user and payload interface subsystem 112 may include and/or incorporate an electrical interface 704 that provides one or more electrical and/or power ports. In this example, the electrical and/or power ports may facilitate and/or support electrical communications or electrical power distribution to one or more devices mounted to and/or incorporated in robotic monitoring system 100.

In some examples, exemplary robotic monitoring system 100 in FIG. 1 may be implemented in a variety of ways. For example, all or a portion of exemplary robotic monitoring system 100 in FIG. 1 may represent portions of exemplary datacenter monitoring system 300 in FIG. 3. As shown in FIG. 3, datacenter monitoring system 300 may include a network 304 that facilitates communication among various computing devices (such as robotic monitoring systems 100(1)-(N) and data integration system 302). Although FIG. 3 illustrates robotic monitoring systems 100(1)-(N) as being external to network 304, robotic monitoring systems 100(1)-(N) may alternatively represent part of and/or be included within network 304.

In some examples, network 304 may include and/or represent various network devices that form and/or establish communication paths and/or segments. For example, network 304 may include and/or represent one or more segment communication paths or channels. Although not necessarily illustrated in this way in FIG. 3, network 304 may include and/or represent one or more additional network devices and/or computing devices.

In some examples, and as will be described in greater detail below, one or more of modules 202 may cause datacenter monitoring system 300 to (1) deploy robotic monitoring systems 100(1)-(N) within a datacenter such that monitoring systems 100(1)-(N) collect information about the datacenter via one or more of sensor 104(1)-(N) as monitoring systems 100(1)-(N) move through the datacenter and transmit the information about the datacenter to data integration system 302, (2) analyze the information about the datacenter at data integration system 302, (3) identify at least one suspicious issue that needs attention within the datacenter based at least in part on the analysis of the information, and then (4) perform at least one action directed to addressing the suspicious issue in response to identifying the at least one suspicious issue.

Data integration system 302 generally represents any type or form of physical computing device or system capable of reading computer-executable instructions, integrating information collected across various robotic monitoring systems, and/or presenting the integrated information for consumption. Examples of data integration system 302 include, without limitation, servers, client devices, laptops, tablets, desktops, servers, cellular phones, Personal Digital Assistants (PDAs), multimedia players, embedded systems, wearable devices, gaming consoles, network devices or interfaces, variations or combinations of one or more of the same, and/or any other suitable data integration systems.

Network 304 generally represents any medium or architecture capable of facilitating communication or data transfer. In some examples, network 304 may include other devices not illustrated in FIG. 3 that facilitate communication and/or form part of communication paths or channels among data integration system 302 and robotic monitoring systems 100(1)-(N). Network 304 may facilitate communication or data transfer using wireless and/or wired connections. Examples of network 304 include, without limitation, an intranet, an access network, a layer 2 network, a layer 3 network, a Multiprotocol Label Switching (MPLS) network, an Internet Protocol (IP) network, a heterogeneous network (e.g., layer 2, layer 3, IP, and/or MPLS) network, a heterogeneous network, a Wide Area Network (WAN), a Local Area Network (LAN), a Personal Area Network (PAN), the Internet, Power Line Communications (PLC), a cellular network (e.g., a Global System for Mobile Communications (GSM) network), a WiFi network, portions of one or more of the same, variations or combinations of one or more of the same, and/or any other suitable network.

FIG. 4 is a block diagram of an exemplary implementation 400 in which mobile data-collection robots 430(1), 430(2), 430(3), 430(4), and/or 430(5) are deployed to collect data from datacenter components 410(1), 410(2), 410(3), and/or 410(4) within a datacenter 404. In some examples, datacenter 404 may include and/or represent a building and/or structure dedicated to housing and/or maintaining various computing systems and/or devices in connection with one or more organizations, service providers, and/or customers. In one example, datacenter 404 may include and/or represent a colocation center or facility in which various computing systems associated with different organizations, service providers, and/or customers are housed or rented. In another example, datacenter 404 may include and/or represent a colocation center or facility in which various computing systems belonging to a single organization, service provider, and/or customer are housed or maintained.

As illustrated in FIG. 4, datacenter 404 may include and/or house various datacenter components 410(1)-(4) that facilitate and/or perform certain computing tasks. In one example, datacenter components 410(1)-(4) may each include and/or represent a row of assorted computing hardware and/or racks assembled within datacenter 404. For example, one or more of datacenter components 410(1)-(4) may include and/or incorporate a set of server racks or cabinets that house certain server components. Examples of such server components include, without limitation, Physical Interface Cards (PICs), Flexible PIC Concentrators (FPCs), Switch Interface Boards (SIBs), linecards, control boards, routing engines, communication ports, fan trays, connector interface panels, servers, network devices or interfaces, routers, optical modules, service modules, rackmount computers, portions of one or more of the same, variations or combinations of one or more of the same, and/or any other suitable server components.

As illustrated in FIG. 4, datacenter 404 may include and/or form aisles 420(1), 420(2), 420(3), 420(4), and/or 420(5) between and/or alongside datacenter components 410(1)-(4). In some examples, mobile data-collection robots 430(1)-(5) may navigate, wander, roam, and/or move through aisles 420(1)-(5) of datacenter 404. While doing so, mobile data-collection robots 430(1)-(5) may sense, capture, record, read, and/or collect various types of data and/or information about the state and/or condition of datacenter 404. In one example, this data and/or information may indicate and/or reflect the state or condition of the environment within datacenter 404. In another example, this data and/or information may indicate and/or reflect the state, condition, or performance of one or more of datacenter components 410(1)-(4). Examples of such data and/or information include, without limitation, video data, photographic data, image data, temperature data, humidity data, infrared data, audio data, pressure data, moisture data, liquid-detection data, computing performance data, representations or derivations of one or more of the same, variations or combinations of one or more of the same, and/or any other suitable data and/or information collected while navigating through datacenter 404.

In some examples, mobile data-collection robots 430(1)-(5) may sense data and/or information about datacenter 404 in a variety of different ways. For example, mobile data-collection robots 430(1)-(5) may read radio-frequency identification tags mounted to datacenter components 410(1)-(4) within datacenter 404 via one or more of sensors 104(1)-(N). In another example, mobile data-collection robots 430(1)-(5) may read certain types of barcodes mounted to datacenter components 410(1)-(4) within datacenter 404 via one or more of sensors 104(1)-(N). By doing so, mobile data-collection robots 430(1)-(5) may obtain and/or receive data and/or information conveyed and/or relayed by the radio-frequency identification tags and/or barcodes.

In a further example, mobile data-collection robots 430(1)-(5) may capture and/or record video and/or photographic images via one or more of sensors 104(1)-(N). In this example, mobile data-collection robots 430(1)-(5) may store these video and/or photographic images and/or process the same via computer or machine vision technology.

In some examples, mobile data-collection robots 430(1)-(5) may report, deliver, and/or transmit the data and/or information sensed within datacenter 404 to data integration system 302. Additionally or alternatively, mobile data-collection robots 430(1)-(5) may process and/or format all or portions of the data and/or information sensed within datacenter 404 prior to performing such transmissions. For example, mobile data-collection robots 430(1)-(5) may generate heat maps, spatial maps, and/or security-alert maps based at least in part on the data and/or information prior to transmitting the same to data integration system 302. In one example, the heat maps may represent and/or be based on temperatures and/or temperature variances detected at datacenter 404. In another example, the heat maps may represent and/or be based on wireless communication signal variances, such as WiFi or Long-Term Evolution (LTE) signal strengths and/or stretches, detected at datacenter 404,

In one example, data integration system 302 may gather, aggregate, and/or integrate the data and/or information as sensed across mobile data-collection robots 430(1)-(5). In this example, data integration system 302 may process and/or format all or portions of the data and/or information sensed by mobile data-collection robots 430(1)-(5). For example, data integration system 302 may generate heat maps, spatial maps, and/or security-alert maps based at least in part on the data and/or information received from mobile data-collection robots 430(1)-(5).

In some examples, data integration system 302 may present and/or display at least some of the data and/or information to an administrator of datacenter 404 (via, e.g., a report and/or user interface). Additionally or alternatively, data integration system 302 may provide an administrator operating another computing device with remote access to at least some of the data and/or information.

In some examples, data integration system 302 and/or mobile data-collection robots 430(1)-(5) may notify an administrator of datacenter 404 about certain security, performance, and/or environmental issues based at least in part on the data and/or information. In one example, data integration system 302 may propagate and/or distribute the data and/or information sensed by mobile data-collection robots 430(1)-(5) to other computing devices associated with the same organization, service provider, and/or customer as the area of datacenter 404 at which the data and/or information was sensed.

In some examples, mobile data-collection robots 430(1)-(5) and/or data integration system 302 may perform certain actions in response to any suspicious issues and/or concerns detected within an area of datacenter 404. For example, one of mobile data-collection robots 430(1)-(5) and/or data integration system 302 may detect and/or discover an unsuitable temperature and/or humidity within a certain area of datacenter 404 based at least in part on information sensed in that area. In this example, one of mobile data-collection robots 430(1)-(5) and/or data integration system 302 may notify the responsible temperature and/or humidity controller of the unsuitable temperature and/or humidity. Additionally or alternatively, one of mobile data-collection robots 430(1)-(5) and/or data integration system 302 may direct and/or instruct the responsible temperature and/or humidity controller to modify the temperature and/or humidity within that area of datacenter 404 to correct and/or adjust the unsuitable temperature and/or humidity.

As another example, one of mobile data-collection robots 430(1)-(5) and/or data integration system 302 may detect and/or discover flooding and/or an unexpected leak within a certain area of datacenter 404 based at least in part on information sensed in that area. In this example, one of mobile data-collection robots 430(1)-(5) and/or data integration system 302 may notify the responsible fluid controller of the flooding and/or unexpected leak. Additionally or alternatively, one of mobile data-collection robots 430(1)-(5) and/or data integration system 302 may direct and/or instruct the responsible fluid controller to shut down and/or close the flow of fluid (e.g., water) to correct and/or fix the flooding or unexpected leak.

In some examples, the data and/or information sensed by mobile data-collection robots 430(1)-(5) may touch and/or traverse various computing layers across datacenter 404. For example, the data and/or information sensed by mobile data-collection robots 430(1)-(5) may be integrated into the existing computing infrastructure within datacenter 404 and/or at another site associated with the corresponding organization, service provider, and/or customer. In one example, mobile data-collection robots 430(1)-(5) may collect data and/or information about datacenter 404 and then transfer the same to a backend device (e.g., data integration system 302). In this example, another device (not necessarily illustrated in FIG. 4) may access and/or process the data and/or information from the backend device. This other device and/or its operator (e.g., a datacenter administrator) may then rely on the data and/or information to make data-driven decisions and/or perform responsive actions based at least in part on the data and/or information.

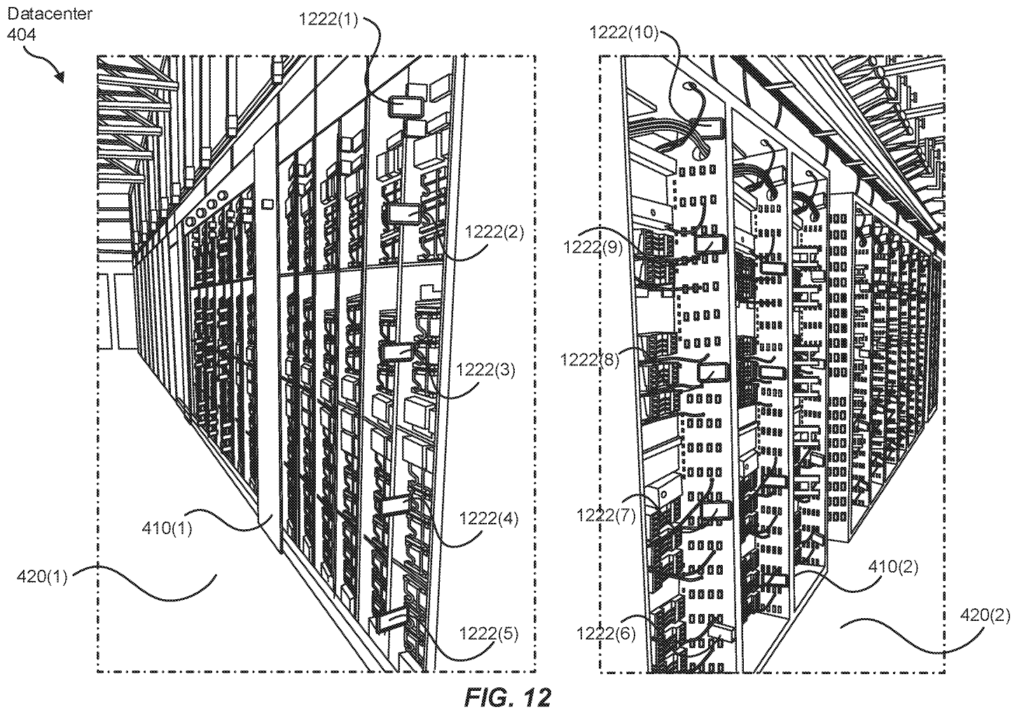

FIG. 12 is an illustration of an exemplary implementation of datacenter 404 in which one or more of robotic monitoring systems 100(1)-(N) are deployed for sensing and/or collecting information about potential security, performance, and/or environmental concerns. As illustrated in FIG. 12, datacenter 404 may include and/or incorporate radio-frequency identification tags 1222(1), 1222(2), 1222(3), 1222(4), 1222(5), 1222(6), 1222(7), 1222(8), 1222(9), and 1222(10) mounted to datacenter components 410(1) and 410(2). Datacenter 404 may also include and/or incorporate various other radio-frequency identification tags that are not explicitly labeled in FIG. 12.

In some embodiments, one or more of radio-frequency identification tags 1222(1)-(10) may include and/or be coupled to active or passive temperature-sensing equipment. In one embodiment, radio-frequency identification tags 1222(1)-(10) may be configured and/or set to produce data representative of surface temperatures along datacenter components 410(1) and 410(2). Additionally or alternatively, radio-frequency identification tags 1222(1)-(10) may be configured and/or set to produce data representative of device temperatures along datacenter components 410(1) and 410(2).

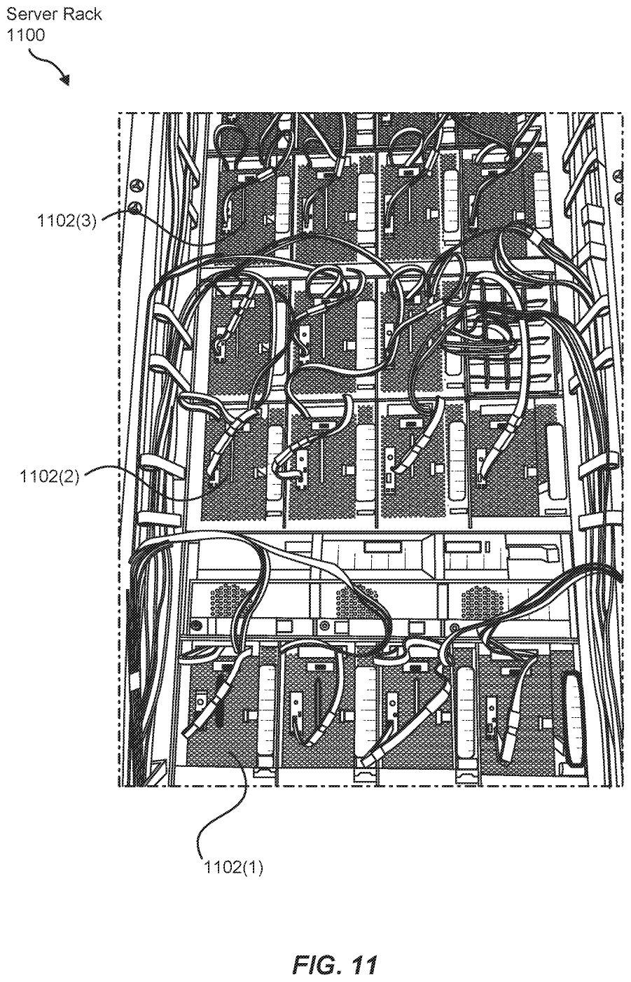

In some embodiments, one or more of radio-frequency identification tags 1222(1)-(10) may be programmed and/or configured to provide identification information specific to a certain device incorporated in datacenter components 410(1) or 410(2). For example, radio-frequency identification tags 1222(1) may be programmed and/or configured with information specific to a server rack 1100 in FIG. 11. Additionally or alternatively, radio-frequency identification tags 1222(2) may be programmed and/or configured with information specific to a field-replaceable unit 1102(2) in FIG. 11.

As a specific example, robotic monitoring system 100(1) may navigate through aisle 420(1) to read information from one or more of radio-frequency identification tags 1222(1)-(5) mounted to datacenter components 410(1). In this example, robotic monitoring system 100(1) may also navigate through aisle 420(2) to read information from one or more of radio-frequency identification tags 1222(6)-(10) mounted to datacenter components 410(2). In one embodiment, the information read from radio-frequency identification tags 1222(1)-(10) may indicate and/or identify current and/or historical temperatures measured at their respective sites and/or positions. In another embodiment, the information read from radio-frequency identification tags 1222(1)-(10) may indicate and/or identify current and/or historical temperatures of one or more electrical and/or computing components installed in server racks along aisles 420(1) and 410(2).

In an additional embodiment, the information read from radio-frequency identification tags 1222(1)-(10) may indicate and/or identify specific assets and/or resources installed and/or running in datacenter components 410(1) or 410(2) within datacenter 404. In one example, robotic monitoring system 100(1) may map and/or associate those assets and/or resources to specific locations and/or positions along datacenter components 410(1) or 410(2) within datacenter 404. In this example, robotic monitoring system 100(1) may transmit at least some of the information read from radio-frequency identification tags 1222(1)-(10) to data integration system 302. By doing so, robotic monitoring system 100(1) may facilitate tracking those assets and/or resources within datacenter 404.

As another example, robotic monitoring system 100(1) may navigate through aisle 420(1) or 420(2) to capture video and/or image data representative of the corresponding environment via high-resolution cameras. In this example, robotic monitoring system 100(1) may feed that video and/or image data to a computer or machine vision application for processing. In various embodiments, robotic monitoring system 100(1) may implement and/or apply one or more artificial intelligence and/or machine learning models.

In some examples, robotic monitoring system 100(1) may implement one or more machine learning algorithms and/or models to facilitate the spatial mapping of datacenter 404 and/or the detection of potential security, performance, and/or environmental concerns. For example, robotic monitoring system 100(1) may be programmed and/or configured with a fully and/or partially constructed machine learning model (such as a convolutional neural network and/or a recurrent neural network). In one example, robotic monitoring system 100(1) may include and/or incorporate a storage device that stores the machine learning model. The machine learning model may be trained and/or constructed with training data that includes various samples of spatial mapping imagery and/or issue detection.

Some of these samples may represent and/or be indicative of certain image and/or video captures. These samples may constitute positive data for the purpose of training the machine learning model with respect to certain surroundings and/or features within datacenter 404. Other samples may represent and/or be indicative of other surroundings and/or features within datacenter 404. These other samples may constitute negative data for the purpose of training the machine learning model with respect to those certain surroundings and/or features within datacenter 404.

In some examples, one or more of these samples may be supplied and/or provided from other similar datacenters for the purpose of training the machine learning model to datacenter 404. Additionally or alternatively, one or more of these samples may be supplied and/or developed by robotic monitoring system 100(1) operating in datacenter 404. For example, robotic monitoring system 100(1) may calibrate and/or train the machine learning model implemented on robotic monitoring system 100(1) to recognize certain surroundings or features and/or to spatially map datacenter 404.

Upon training and/or calibrating the machine learning model, robotic monitoring system 100(1) may be able to classify and/or identify certain features captured and/or shown in subsequent video and/or images. For example, robotic monitoring system 100(1) may detect, via the machine learning model, a pattern indicative of certain surroundings and/or features within those videos and/or images. In this example, robotic monitoring system 100(1) and/or data integration system 302 may then use the detection of such surroundings and/or features to spatially map datacenter 404 and/or perform localization on the same.

As a specific example, the machine learning model may represent a convolutional neural network that includes various layers, such as one or more convolution layers, activation layers, pooling layers, and fully connected layers. In this example, robotic monitoring system 100(1) may pass video and/or image data through the convolutional neural network to classify and/or identify certain surroundings and/or features represented in the video and/or image data.

In the convolutional neural network, the video and/or image data may first encounter the convolution layer. At the convolution layer, the video and/or image data may be convolved using a filter and/or kernel. In particular, the video and/or image data may cause computation and navigation subsystem 108 to slide a matrix function window over and/or across the video and/or image data. Computation and navigation subsystem 108 may then record the resulting data convolved by the filter and/or kernel. In one example, one or more nodes included in the filter and/or kernel may be weighted by a certain magnitude and/or value.

After completion of the convolution layer, the convolved representation of the video and/or image data may encounter the activation layer. At the activation layer, the convolved data in the video and/or image data may be subjected to a non-linear activation function. In one example, the activation layer may cause computation and navigation subsystem 108 to apply the non-linear activation function to the convolved data in the video and/or image data. By doing so, computation and navigation subsystem 108 may be able to identify and/or learn certain non-linear patterns, correlations, and/or relationships between different regions of the convolved data in the electrical response.

In some examples, computation and navigation subsystem 108 may apply one or more of these layers included in the convolutional neural network to the video and/or image data multiple times. As the video and/or image data completes all the layers, the convolutional neural network may render a classification for the video and/or image data. In one example, the classification may indicate that a certain feature captured in the video and/or image data is indicative of a known feature, device, and/or structure.

In some examples, robotic monitoring systems 100(1)-(N) may implement cross-check security features to authenticate the identities of personnel within datacenter 404. For example, robotic monitoring system 100(1) may encounter personnel wandering the aisles of datacenter 404. In this example, robotic monitoring system 100(1) may obtain identification credentials (e.g., name, employee number, department, job title, etc.) from a badge and/or radio-frequency identification tag worn by the personnel via one or more of sensors 104(1)-(N).

Continuing with this example, robotic monitoring system 100(1) may obtain image data (e.g., video and/or still photography) of the personnel detected with datacenter 404. In one example, robotic monitoring system 100(1) may receive and/or access existing photographic images of the personnel from an employee identification database. Additionally or alternatively, computation and navigation subsystem 108 may include a facial recognition interface that obtains image data that is captured of the personnel during the encounter. In this example, computation and navigation subsystem 108 may determine any suspected identities of the personnel based at least in part on the image data captured during the encounter.

In one example, computation and navigation subsystem 108 may include a security interface that compares the identification credentials obtained from the personnel to the suspected identities of the personnel. In this example, the security interface may determine whether the identification credentials from the personnel match and/or correspond to the suspected identifies of the personnel. On the one hand, if the identification credentials match the suspected identity of the person encountered in datacenter 404, robotic monitoring system 100(1) may effectively confirm that the person is represented correctly and/or accurately by his or her identification credentials, thereby authenticating his or her identity. On the other hand, if the identification credentials do not match the suspected identity of the person encountered in datacenter 404, robotic monitoring system 100(1) may effectively confirm that the person is potentially misrepresenting himself or herself by the identification credentials worn while wandering datacenter 404. This potential misrepresentation may constitute and/or amount to a security concern that needs attention from an administrator.

In some examples, robotic monitoring systems 100(1)-(N) and/or data integration system 302 may identify and/or determine high foot-traffic areas within datacenter 404. In one example, one or more of robotic monitoring systems 100(1)-(N) may be deployed to those high foot-traffic areas at less busy times (e.g., once the level of foot traffic decreases) for the purpose of sanitizing those areas with ultraviolet light and/or acoustic vibration generators. By doing so, one or more of robotic monitoring systems 100(1)-(N) may be able to mitigate the risk of viral spreading within those areas.

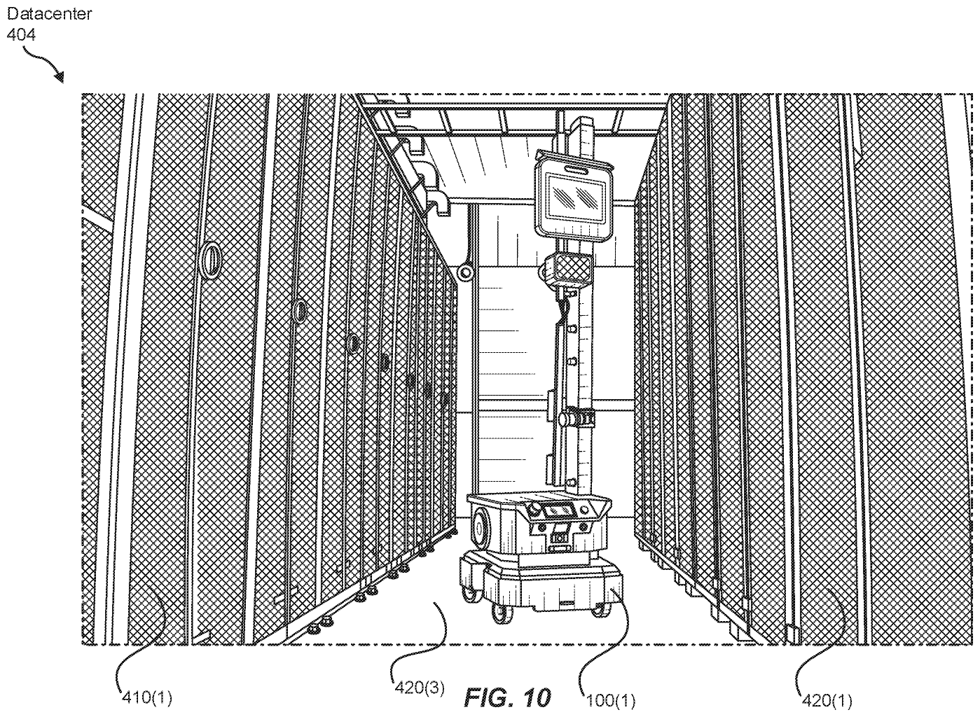

FIG. 10 is an illustration of an exemplary implementation of datacenter 404 in which one or more of robotic monitoring systems 100(1)-(N) are deployed for sensing and/or collecting information about potential security, performance, and/or environmental concerns. For example, as illustrated in FIG. 10, robotic monitoring system 100(1) may capture video and/or image data while navigating through aisle 420(3) of datacenter 404. In this example, robotic monitoring system 100(1) may be able to spatially map that area of datacenter 404 and/or detect certain features within that area of datacenter 404 based at least in part on that video and/or image data.

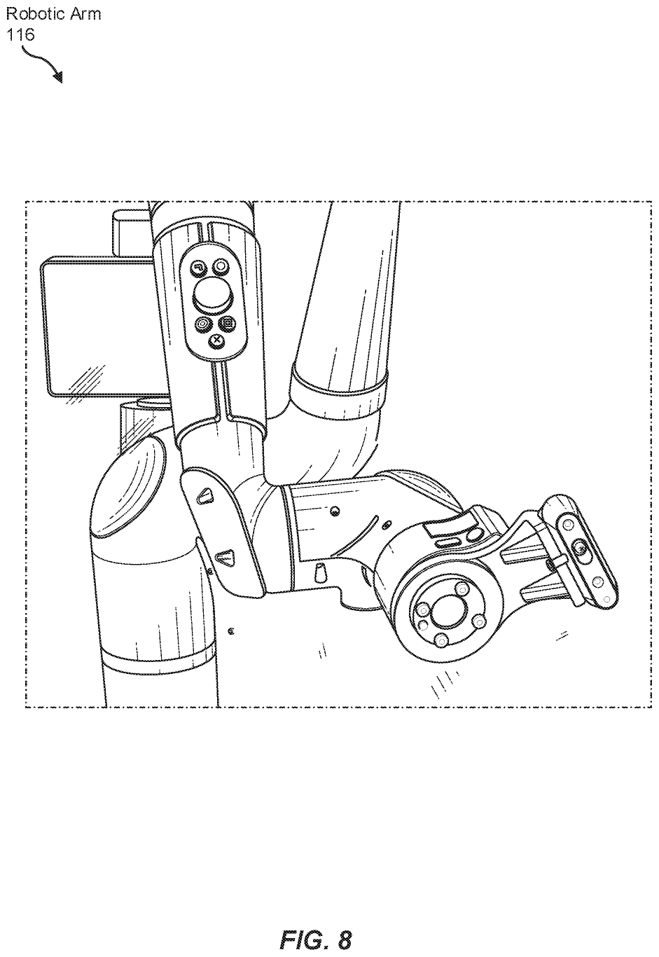

FIG. 8 is an illustration of an exemplary implementation of robotic arm 116 for moving, replacing, and/or modifying hardware and/or devices in datacenter 404. For example, robotic monitoring system 100(1) may be configured and/or assembled with robotic arm 116 such that robotic arm 116 is controlled by and/or synchronized with computation and/or navigation subsystem 108. In one example, robotic monitoring system 100(1) may be able to use robotic arm 116 to move, replace, and/or modify one or more of field-replaceable units 1102(1), 1102(2), and/or 1102(3) installed in server rack 1100 in FIG. 11.

In some examples, field-replaceable units 1102(1)-(3) may constitute and/or represent a modular device that includes one or more ports and/or interfaces for carrying and/or forwarding network traffic. Examples of field-replaceable units 1102(1)-(3) include, without limitation, PICs, FPCs, SIBs, linecards, control boards, routing engines, communication ports, fan trays, connector interface panels, servers, network devices or interfaces, routers, optical modules, service modules, rackmount computers, portions of one or more of the same, combinations or variations of one or more of the same, and/or any other suitable FRUs.

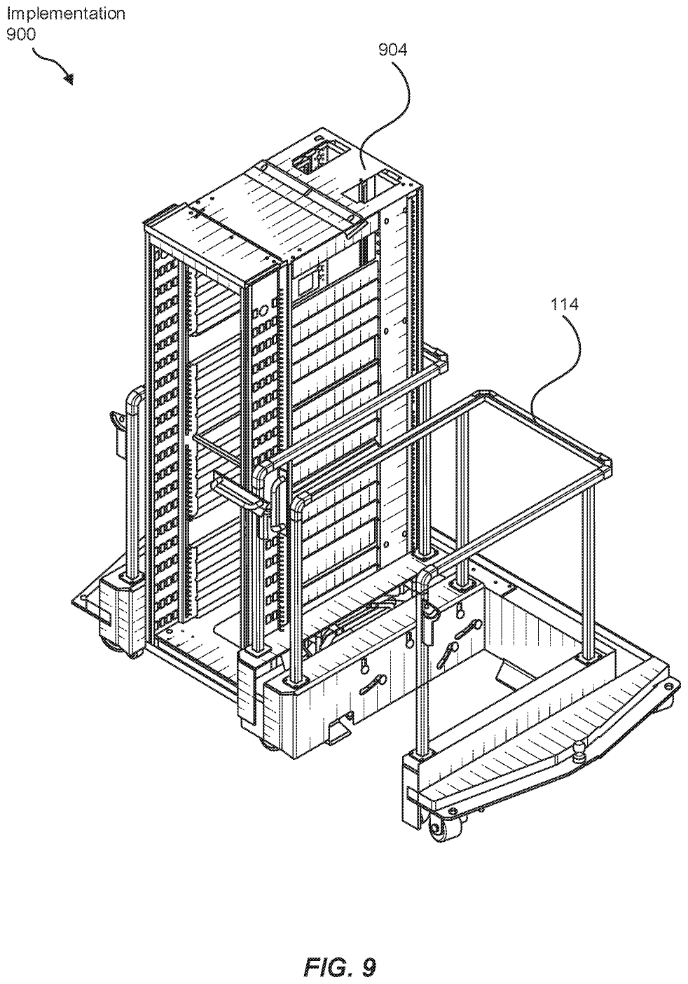

FIG. 9 is an illustration of an exemplary implementation 900 of rack dolly subsystem 114 for moving, replacing, and/or relocating server racks in datacenter 404. For example, robotic monitoring system 100(1) may be configured and/or assembled with rack dolly subsystem 114 such that rack dolly subsystem 114 is controlled and/or directed by robotic monitoring system 100(1). In one example, robotic monitoring system 100(1) may be able to use rack dolly subsystem 114 to move, replace, and/or relocate a server rack 904 in FIG. 9.

FIG. 13 is a flow diagram of an exemplary method 1300 for robotic datacenter monitoring. The steps shown in FIG. 14 may be performed by certain devices deployed in a datacenter for the purpose of collecting data and/or making decisions in connection with the datacenter based at least in part on such data. Moreover, the steps shown in FIG. 13 may also incorporate and/or involve various sub-steps and/or variations consistent with the descriptions provided above in connection with FIGS. 1-12.

As illustrated in FIG. 13, at step 1310, mobile data-collection robots may be deployed within a datacenter. For example, an administrator and/or a robot controller may deploy mobile data-collection robots within a datacenter. In this example, as part of the deployment at step 1310(1) in FIG. 13, the mobile data-collection robots may collect information about the datacenter via at least one sensor as the mobile data-collection robots move through the datacenter. Additionally or alternatively, as part of the deployment at step 1310(2) in FIG. 13, the mobile data-collection robots may transmit the information about the datacenter to a data integration system.

At step 1320 in FIG. 13, the information collected by the mobile data-collection robots may be analyzed at the data integration system. For example, the data integration system and/or its operator (e.g., a datacenter administrator) may evaluate and/or compare the information collected by the mobile data-collection robots. In this example, the evaluation and/or comparison may indicate and/or suggest that one or more suspicious issues exist or occurred within the datacenter. Such suspicious issues may necessitate the attention of a computing device (e.g., a maintenance robot and/or an environmental controller) and/or a datacenter administrator.

At step 1330 in FIG. 13, at least one suspicious issue that needs attention within the datacenter may be identified based at least in part on the analysis of the information. For example, the data integration system and/or its operator (e.g., a datacenter administrator) may identify at least one suspicious issue that needs attention within the datacenter based at least in part on the analysis of the information. Examples of such suspicious issues include, without limitation, temperature spikes, unexpected noises, electrical load increases, fluid leaks, pressure variances, combinations or variations of one or more of the same, and/or any other potentially suspicious issues.

At step 1340 in FIG. 13, at least one action directed to addressing the at least one suspicious issue may be performed in response to identifying the at least one suspicious issue. For example, the data integration system and/or its operator (e.g., a datacenter administrator) may perform certain actions directed to addressing the suspicious issue. As a specific example, the data integration system and/or its operator may modify one or more environmental controls (e.g., temperature, humidity, and/or fluid flow) to address the suspicious issue identified in connection with the analysis performed on the collected information. Additionally or alternatively, the data integration system and/or its operator may notify a maintenance administrator of the suspicious issue and/or instruct the maintenance administrator to correct the suspicious issue to mitigate potential disturbances and/or downtime at the datacenter.

As described above in connection with FIGS. 1-13, the disclosed robotic monitoring systems may include a mobility subsystem, a computation and navigation subsystem, a user and payload interface subsystem, and/or a payload subsystem. The robotic monitoring system may be configured for moving about (e.g., utilizing the mobility and computation and navigation subsystems), monitoring (e.g., utilizing the user and payload interface and payload subsystems), and/or transmitting gathered information from (e.g., utilizing the computation and navigation and user and payload interface subsystems) a datacenter.

In some examples, the mobility subsystem and the computation and navigation subsystem of the robotic system may be a core unit of the robotic system. The mobility subsystem and the computation and navigation subsystem may include a computation assembly (including, e.g., at least one processor and associated computational elements, memory, and/or a communication element, such as a wireless or a wired communication element, etc.), a drivetrain (including, e.g., at least one motor, and/or wheels, etc.), a navigation sensing assembly (including, e.g., a proximity sensor, an accelerometer, a gyroscope, and/or a location sensor, etc.), power systems (including, e.g., a power source, such as a battery, a power transmission element, a power supply element, and/or a charging element, etc.), and/or an emergency stop element (e.g., a brake).

In some examples, the user and payload interface subsystem and the payload subsystem may include a peripherals and sensing mast. This mast may be configured to support peripherals and sensing elements, such as for monitoring the datacenter. For example, the peripherals and sensing elements may be designed for datacenter and POP-site applications. Video-calling hardware infrastructure may also be included for a remote user to participate in a video call at the robotic system, to view the datacenter, and/or to communicate with a local user at or near the robotic system in the datacenter. The peripherals and sensing elements may also include one or more radio-frequency identification readers, such as to track assets (e.g., computing devices, infrastructure elements, etc.), to read information from radio-frequency identification badges, and/or to monitor temperature at radio-frequency identification tags positioned in the datacenter. Such radio-frequency identification tags are discussed further below. The peripherals and sensing elements may also include one or more cameras, such as high-definition cameras, for machine vision applications and/or for remote visual monitoring of the datacenter. Flash elements, such as custom flash bars, may be positioned on the mast to provide a light source to improve image captures.

In some examples, radio-frequency identification tags may be used to identify computing assets (e.g., servers, memory, processors, networking devices, etc.) and/or supporting infrastructure (e.g., racks, conduit, lighting, etc.). In some examples, temperature-sensing radio-frequency identification tags may be used to produce data corresponding to the temperature of an environment (e.g., air), surface, or device adjacent to the radio-frequency identification tag. For example, the radio-frequency identification tags and/or the robotic monitoring system may be configured to read hot aisle air temperature and/or cold aisle air temperature.

In some embodiments, a difference between intake air temperature and exhaust air temperature on servers may be measured. In addition, temperature-sensing radio-frequency identification tags may be employed to measure surface temperatures, such as on a busway to enable early detection of potential failures like arc flash failures. The robotic monitoring system may be configured to read identification data and/or temperature data from the radio-frequency identification tags. In the case of temperature-sensing, the radio-frequency identification tags may be positioned on or adjacent to devices or surfaces susceptible to overheating. Additionally or alternatively, the radio-frequency identification tags may provide an indication of part wear or failure in the form of heat. When an unexpected high temperature is sensed by a passing robotic monitoring device, a communication may be sent to maintenance personnel to check the area, device, or surface associated with the radio-frequency identification tag for potential maintenance or replacement.

In some examples, active (e.g., electrically powered) radio-frequency identification tags may be employed in the datacenter and configured to provide information to the robotic monitoring system. For example, active radio-frequency identification tags may be positioned on or near machines that have moving parts, such as large intake and exhaust fans on cooling/heating equipment, to provide analytics and feedback regarding operation and/or potential failures of these machines. In addition, active radio-frequency identification tags may be able to actively broadcast information to the robotic monitoring system at a longer range than passive radio-frequency identification tags.

In some examples, the payload interface may be a base unit designed for modularity. The payload interface may include a “breadboard” mechanical design and/or an electrical interface having electrical outputs and communications interfaces (e.g., power, ethernet, universal serial bus (“USB”), a serial port, a video connection port, etc.). A mechanical interface may include an array of holes for mechanically connecting devices or objects to the payload interface and/or for the robotic monitoring system to carry the devices or objects. The devices or objects carried by the payload interface may, in some cases, include a computing device that necessitates a connection to the robotic monitoring system by the electrical interface.

Various specifications of the robotic monitoring system may be possible. In some examples, values for each of the specifications may be selected by one skilled in the art, depending on an expected application for the robotic monitoring system. Thus, the values of the specifications outlined below are intended as an example of a particular way in which the robotic monitoring system may be configured.

By way of example and not limitation, the robotic monitoring system may fit within an 18-inch by 22-inch cross-sectional area, such as to fit so-called POP and datacenter applications. In some embodiments, the base weight may be approximately 46 kg, and the mast portion of the robotic monitoring system may have a weight of approximately 14 kg. A top speed of the example robotic monitoring system may be about 2 m/s (e.g., with software limits in place to reduce the speed for safety and/or effectiveness) with an average operating speed of about 0.5 m/s.

In some embodiments, the robotic monitoring system may be configured to achieve autonomous navigation in known, mapped-out spaces. In some examples, the robotic monitoring system may be powered by an onboard 480 watt-hour battery, which may provide about 8 hours of runtime per full charge. The robotic monitoring system may be configured and/or programmed to return to a docking station, such as for storage and/or recharging of the power source.

In some embodiments, the robotic monitoring system may be equipped for video calling, such as for a remote user to view a captured image at the robotic monitoring system's location and/or to display an image of the user at the robotic monitoring system, such as to communicate with a local user near the robotic monitoring system. For example, the robotic monitoring system may include at least one video camera, at least one display screen, at least one microphone, and/or at least one audio output device. The robotic monitoring system may also include computer vision systems and/or radio-frequency identification tracking elements, such as for asset tracking. In addition, the robotic monitoring system may include environmental sensing systems, such as to sense temperature, humidity, air pressure, etc.

In some examples, a datacenter may include temperature sensing elements on busways, hot aisle temperature profiling, and/or air temperature sensor arrays. Additionally or alternatively, the robotic monitoring system may include security features. For example, improved surveillance payloads (e.g., cameras movable along multiple axes, infrared cameras, etc.) may be included. In another example, the robotic monitoring system may include a leak detection system (e.g., a liquid-sensing system) to provide alerts in case of flooding or other liquid (e.g., water) leaks. By way of example and not limitation, humidity-sensing or moisture-sensing radio-frequency identification tags may be positioned in the datacenter under or near potential liquid sources (e.g., water pipes, coolant pipes, etc.). In some examples, the moisture-sensing (or other) radio-frequency identification tags may be positioned in locations that are out of a line-of-sight from aisles in the datacenter. The robotic monitoring system may read these radio-frequency identification tags when passing through a corresponding geographical area and may receive information regarding potential leaks.

In some examples, the robotic monitoring system may be capable of collecting a variety of data types. For example, the robotic monitoring system may include subsystems for collecting temperature data, generating heat maps, recording air flow data, monitoring air pressure, etc. In some examples, the robotic monitoring system may include elements configured for server rack movement. For example, a rack dolly system may be shaped, sized, and configured to lift a server rack and move the server rack to another location in a datacenter. The rack dolly system may include at least one lift mechanism and at least one roller element to lift the server racks and move the server racks to another location. The rack dolly system may improve safety and efficiency when moving racks relative to conventional (e.g., manual) methods. The rack dolly system may be used for deployments (e.g., installation), decommissions (e.g., removal), and shuffling of server racks within a datacenter.

In some examples, additional robotics concepts employed by the robotic monitoring system may include manipulation collaboration. For example, the robotic monitoring system may include and/or be used in conjunction with artificial intelligence and machine learning, such as to develop fundamental control algorithms for robust grasping and/or to develop computer vision improvements and protocols, etc. A framework for scalable systems (e.g., kinematic retargeting, sensor auto-recalibration, etc.) may be included in the robotic monitoring system. Such concepts may be applicable to infrastructure robotics efforts (e.g., to the robotic monitoring system for datacenters as disclosed herein).

In some examples, additional robotics concepts, such as hardware manipulation collaboration, may be implemented with the robotic monitoring system. For example, manipulation applications in manufacturing may be applicable to the robotic monitoring system. Hardware engineering and quality testing using robotic arms (e.g., network connectors) may be facilitated and/or controlled by the robotic monitoring system. Accordingly, during the production of datacenter infrastructure, the design and/or configuration may take into consideration robotic manipulation by the robotic monitoring system.

In some examples, the robotic monitoring system may also be configured for spatial computing mapping and localization. For example, spatial computing may be used to improve certain infrastructures. Three-dimensional (“3D”) mapping and localization may, in some examples, significantly improve the safety and/or reliability of robotic monitoring systems deployed in a datacenter. In addition, spatial computing mapping and localization may decrease the cost of sensor systems employed by the robotic monitoring systems, such as by providing mapping and localization data for robotic monitoring systems deployed in the datacenter. Robust and/or reliable data collection may be provided for experimentation with algorithms and/or other approaches. Such concepts may leverage mobile robots for client-side testing that addresses client-specific needs.

In some examples, spatial computing mapping and localization collaboration of the robotic monitoring system may be used in a number of applications, such as to map an area, to use computer vision to identify certain physical features in an area, and/or to provide augmented-reality mapping and direction systems.

In some examples, software specifications employed by or with the robotic monitoring system may include an application layer, a transport layer, a network layer, and/or a physical layer. For example, the application layer may include a graphical remote control user interface, future tools, etc. The transport layer may include software tools, web RTC, messenger, etc. The network layer may include software for connectivity, internal backend, etc. The physical layer may include software for wireless (e.g., WiFi, BLUETOOTH, etc.) connectivity, a modular sensor suite, etc.

In some examples, the robotic monitoring system may integrate with existing infrastructure. For example, the robotic monitoring system may collect data and/or transfer the collected data to a backend system where the data is accessed and/or processed. In this example, data-driven decisions may be made based at least in part on the data analysis. Such decisions may include and/or necessitate gathering additional data by the robotic monitoring system.

In some examples, the robotic monitoring system may have a number of system capabilities, such as for navigation, environmental sensing, telecommunications, asset tracking, and/or manipulation. By way of example and not limitation, the robotic monitoring system may include navigation mechanisms such as LIDAR-based SLAM systems, vision-based docking systems, and/or cloud-based map storage. In environmental sensing, the robotic monitoring system may include humidity sensing, temperature sensing, pressure sensing, leak detection, etc. In telecommunications, the robotic monitoring system may include video calling, audio calling, auto pick-up, etc. In asset tracking, the robotic monitoring system may include an radio-frequency identification reader, a vision-based barcode scanner, asset infrastructure integrations, etc. In manipulation, the robotic monitoring system may include guided pose-to-pose object grasping.

In some examples, the system capabilities described above may be used in a variety of combinations with one another. For example, the LIDAR-based SLAM systems may be used for guided pose-to-pose object grasping, the temperature sensing may be accomplished using an RFID tag reader, the video and audio calling may be used together, cloud-based map storage may be utilized in connection with auto pick-up and/or asset infrastructure integrations, and vision-based docking systems may be used in conjunction with a vision-based barcode scanner. Additional overlapping uses and systems may be employed by the robotic monitoring systems.

### Example Embodiments

Example 1: A robotic monitoring system comprising (1) a mobility subsystem for moving the robotic monitoring system through a datacenter, (2) at least one sensor for sensing information about the datacenter as the robotic monitoring system moves through the datacenter, (3) a payload subsystem for mounting the at least one sensor to the robotic monitoring system, and/or (4) a computation and navigation subsystem for recording the information about the datacenter and controlling the mobility subsystem.

Example 2: The robotic monitoring system of Example 1, wherein the at least one sensor comprises at least one of (1) a radio-frequency identification sensor, (2) a video camera, (3) an infrared camera, (4) an audio microphone, (5) a pressure sensor, or (6) a liquid sensor.

Example 3: The robotic monitoring system of any of Examples 1 and 2, wherein the at least one sensor comprises a radio-frequency identification sensor configured to sense temperature information from one or more radio-frequency identification tags mounted in the datacenter.

Example 4: The robotic monitoring system of any of Examples 1-3, wherein the computation and navigation subsystem comprises a heat map generator configured to generate, based at least in part on temperatures identified within the temperature information, a heat map corresponding to at least a portion of the datacenter.

Example 5: The robotic monitoring system of any of Examples 1-4, wherein the at least one sensor comprises a radio-frequency identification sensor configured to sense asset-tracking information from one or more radio-frequency identification tags mounted in the datacenter.

Example 6: The robotic monitoring system of any of Examples 1-5, further comprising a transmission subsystem for transmitting the information about the datacenter to a data integration system configured to integrate sets of information about the datacenter as gathered by the robotic monitoring system and at least one additional robotic monitoring system while moving through the datacenter.

Example 7: The robotic monitoring system of any of Examples 1-6, wherein the payload subsystem is further configured for mounting, to the robotic monitoring system, at least one of (1) a light source, (2) an audio speaker, or (3) a display device.

Example 8: The robotic monitoring system of any of Examples 1-7, further comprising a user and payload interface subsystem that includes a mechanical interface for mounting an object to the robotic monitoring system.

Example 9: The robotic monitoring system of any of Examples 1-8, further comprising a user and payload interface subsystem that includes an electrical interface for providing at least one of electrical communications or electrical power to a device mounted to the robotic monitoring system.

Example 10: The robotic monitoring system of any of Examples 1-9, further comprising a rack dolly subsystem for moving at least one server rack from one location to another location within the datacenter.

Example 11: The robotic monitoring system of any of Examples 1-10, further comprising a robotic arm for modifying at least one hardware component located within the datacenter.

Example 12: The robotic monitoring system of any of Examples 1-11, wherein (1) the at least one senor is further configured to obtain identification credentials from personnel detected within the datacenter and (2) the computation and navigation subsystem comprises (A) a facial recognition interface for (I) obtaining image data representative of the personnel detected within the datacenter and (II) determining suspected identities of the personnel detected within the datacenter based at least in part on the image data and (B) a security interface for (I) comparing the identification credentials obtained from the personnel to the suspected identities of the personnel and (II) determining, based at least in part on the comparison, whether the identification credentials from the personnel correspond to the suspected identifies of the personnel.

Example 13: The robotic monitoring system of any of Examples 1-12, wherein the computation and navigation subsystem is further configured to (1) obtain the information about the datacenter from the at least one sensor and (2) detect at least one security event within the datacenter based at least in part on the information about the datacenter, and further comprising a transmission subsystem for transmitting a notification about the security event to one or more personnel at the datacenter.

Example 14: A datacenter monitoring system comprising (1) mobile data-collection robots deployed within a datacenter, wherein the mobile data-collection robots include (A) a mobility subsystem for moving the mobile data-collection robots through the datacenter, (B) at least one sensor for sensing information about the datacenter as the mobile data-collection robots move through the datacenter, (3) a payload subsystem for mounting the at least one sensor to the mobile data-collection robots, and (5) a computation and navigation subsystem for recording the information about the datacenter and controlling the mobility subsystem, and (2) a data integration system communicatively coupled to the mobile data-collection robots, wherein the data integration system is configured to integrate the information about the datacenter as collected by the mobile data-collection robots while moving through the datacenter.

Example 15: The datacenter monitoring system of Example 14, wherein the at least one sensor comprises at least one of (1) a radio-frequency identification sensor, (2) a video camera, (3) an infrared camera, (4) an audio microphone, (5) a pressure sensor, or (6) a liquid sensor.

Example 16: The datacenter monitoring system of any of Examples 14 and 15, wherein the at least one sensor comprises a radio-frequency identification sensor configured to sense temperature information from one or more radio-frequency identification tags mounted in the datacenter.

Example 17: The datacenter monitoring system of any of Examples 14-16, wherein the computation and navigation subsystem comprises a heat map generator configured to generate, based at least in part on temperatures identified within the temperature information, a heat map corresponding to at least a portion of the datacenter.

Example 18: The datacenter monitoring system of any of Examples 14-17, wherein the at least one sensor comprises a radio-frequency identification sensor configured to sense asset-tracking information from one or more radio-frequency identification tags mounted in the datacenter.

Example 19: The datacenter monitoring system of any of Examples 14-18, wherein the mobile data-collection robots further include a transmission subsystem for transmitting the information about the datacenter to the data integration system.

Example 20: A method comprising (1) deploying mobile data-collection robots within a datacenter such that the mobile data-collection robots (A) collect information about the datacenter via at least one sensor as the mobile data-collection robots move through the datacenter and (B) transmit the information about the datacenter to a data integration system, (2) analyzing the information about the datacenter at the data integration system, (3) identifying at least one suspicious issue that needs attention within the datacenter based at least in part on the analysis of the information, and then in response to identifying the at least one suspicious issue, (4) performing at least one action directed to addressing the at least one suspicious issue.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. One or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A robotic monitoring system comprising:
a mobility subsystem for moving the robotic monitoring system through a datacenter;
at least one sensor for sensing information about the datacenter as the robotic monitoring system moves through the datacenter;
a payload subsystem for mounting the at least one sensor to the robotic monitoring system; and
a computation and navigation subsystem for recording the sensing information about the datacenter and controlling the mobility subsystem.

2. The robotic monitoring system of claim 1, wherein the at least one sensor comprises at least one of:
a radio-frequency identification sensor;
a video camera;
an infrared camera;
an audio microphone;
a pressure sensor;
a liquid sensor;
an air velocity sensor;
a high-resolution machine vision camera;
a temperature sensor; or a humidity sensor.

3. The robotic monitoring system of claim 1, wherein the at least one sensor comprises a radio-frequency identification sensor configured to sense temperature information from one or more radio-frequency identification tags mounted in the datacenter.

4. The robotic monitoring system of claim 1, wherein the computation and navigation subsystem comprises a heat map generator configured to generate, based at least in part on information collected within the datacenter, a heat map corresponding to at least a portion of the datacenter, the information identifying at least one of:
temperature variances across the portion of the datacenter; or
wireless communication signal variances across the portion of the datacenter.

5. The robotic monitoring system of claim 1, wherein the at least one sensor comprises a radio-frequency identification sensor configured to sense asset-tracking information from one or more radio-frequency identification tags mounted in the datacenter.

6. The robotic monitoring system of claim 1, further comprising a transmission subsystem for transmitting the information about the datacenter to a data integration system configured to integrate sets of information about the datacenter as gathered by the robotic monitoring system and at least one additional robotic monitoring system while moving through the datacenter.

7. The robotic monitoring system of claim 6, wherein the transmission subsystem is further configured to enable the data integration system to:
identify, in connection with the information, at least one suspicious issue that needs attention within the datacenter; and
perform at least one action directed to addressing the at least one suspicious issue in response to identifying the at least one suspicious issue.

8. The robotic monitoring system of claim 1, wherein the payload subsystem is further configured for mounting, to the robotic monitoring system, at least one of:
a video camera;
a still camera;
a temperature sensor;
an audio speaker; or
a display device.

9. The robotic monitoring system of claim 1, further comprising a user and payload interface subsystem that includes a mechanical interface for mounting an object to the robotic monitoring system.

10. The robotic monitoring system of claim 1, further comprising a user and payload interface subsystem that includes an electrical interface for providing at least one of electrical communications or electrical power to a device mounted to the robotic monitoring system.

11. The robotic monitoring system of claim 1, further comprising a rack dolly subsystem for moving at least one server rack from one location to another location within the datacenter.

12. The robotic monitoring system of claim 1, further comprising a robotic arm for modifying at least one hardware component located within the datacenter.

13. The robotic monitoring system of claim 1, wherein:
the at least one senor is further configured to obtain identification credentials from personnel detected within the datacenter; and
the computation and navigation subsystem comprises:
a facial recognition interface for:
obtaining image data representative of the personnel detected within the datacenter; and
determining suspected identities of the personnel detected within the datacenter based at least in part on the image data; and
a security interface for:
comparing the identification credentials obtained from the personnel to the suspected identities of the personnel; and
determining, based at least in part on the comparison, whether the identification credentials from the personnel correspond to the suspected identifies of the personnel.

14. The robotic monitoring system of claim 1, wherein the computation and navigation subsystem is further configured to:
obtain the information about the datacenter from the at least one sensor; and
detect at least one security event within the datacenter based at least in part on the information about the datacenter; and
further comprising a transmission subsystem for transmitting a notification about the security event to one or more personnel at the datacenter.

15. A datacenter monitoring system comprising:
mobile data-collection robots deployed within a datacenter, wherein the mobile data-collection robots include:
a mobility subsystem for moving the mobile data-collection robots through the datacenter;
at least one sensor for sensing information about the datacenter as the mobile data-collection robots move through the datacenter;
a payload subsystem for mounting the at least one sensor to the mobile data-collection robots; and
a computation and navigation subsystem for recording the information about the datacenter and controlling the mobility subsystem; and
a data integration system communicatively coupled to the mobile data-collection robots, wherein the data integration system is configured to integrate the information about the datacenter as collected by the mobile data-collection robots while moving through the datacenter.

16. The datacenter monitoring system of claim 15, wherein the at least one sensor comprises at least one of:
a radio-frequency identification sensor;
a video camera;
an infrared camera;
an audio microphone;
a pressure sensor;
a liquid sensor;
an air velocity sensor;
a high-resolution machine vision camera;
a temperature sensor; or
a humidity sensor.

17. The datacenter monitoring system of claim 15, wherein the at least one sensor comprises a radio-frequency identification sensor configured to sense temperature information from one or more radio-frequency identification tags mounted in the datacenter.

18. The datacenter monitoring system of claim 15, wherein the at least one sensor comprises a radio-frequency identification sensor configured to sense asset-tracking information from one or more radio-frequency identification tags mounted in the datacenter.

19. The datacenter monitoring system of claim 15, wherein the data integration system is further configured to:
identify, in connection with the information, at least one suspicious issue that needs attention within the datacenter; and
perform at least one action directed to addressing the at least one suspicious issue in response to identifying the at least one suspicious issue.

20. A method comprising:
deploying mobile data-collection robots within a datacenter such that the mobile data-collection robots:
collect information about the datacenter via at least one sensor as the mobile data-collection robots move through the datacenter; and
transmit the information about the datacenter to a data integration system;
analyzing the information about the datacenter at the data integration system; and
identifying at least one suspicious issue that needs attention within the datacenter based at least in part on the analysis of the information; and
in response to identifying the at least one suspicious issue, performing at least one action directed to addressing the at least one suspicious issue.
